(19) United States
(12) Patent Application Publication
(10) Pub. No.: US 2026/0212497 A1
(43) Pub. Date: Jul. 23, 2026

(54) FOUR-DIMENSIONAL CARDIAC MOTION RECONSTRUCTION METHOD BASED ON HYBRID REPRESENTATION ENHANCEMENT

(71) Applicant: General Hospital of Northern Theater Command of the People's Liberation Army, Shenyang (CN)

(72) Inventors: Yuji Zhang, Shenyang (CN); Huishan Wang, Shenyang (CN); Guannan Liu, Shenyang (CN); Fangran Xin, Shenyang (CN); Huaiyang Liu, Shenyang (CN)

(21) Appl. No.: 19/284,402

(22) Filed: Jul. 29, 2025

(30) Foreign Application Priority Data
Jan. 17, 2025 (CN) 202510075625.2

(51) Int. Cl. G06T 7/00; G06N 3/0464

(52) U.S. Cl. CPC G06T 7/0012; G06N 3/0464; G06T 2207/30048

(57) ABSTRACT

Disclosed is a four-dimensional (4D) cardiac motion reconstruction method based on hybrid representation enhancement, including the steps of: S1, cardiac model parameterization; S2, generation of initial three-dimensional (3D) model; S3, construction of observation encoder; S4, cardiac motion recovery; and S5, network model training. Through a deep marching tetrahedra (DMTet) algorithm, 3D space is discretized into a deformable tetrahedral mesh, providing a foundation for subsequent model training to capture finer geometric details. Furthermore, during 3D reconstruction, a hybrid representation enhancement method is employed, which combines implicit surface representation and explicit mesh representation techniques. Based on the observation encoder, this method is used for extracting features from various types of observational data, and these extracted features are leveraged for subsequent cardiac motion recovery. During motion recovery, a graph convolutional network (GCN) and a gated recurrent unit (GRU) are combined to help the model process spatial and temporal information.

### CROSS-REFERENCE TO RELATED APPLICATION

This application claims priority of Chinese Patent Application No. 202510075625.2, filed on Jan. 17, 2025, the entire contents of which are incorporated herein by reference.

### TECHNICAL FIELD

The present disclosure relates to the interdisciplinary technical field of deep learning and medical image reconstruction, and specifically to a four-dimensional (4D) cardiac motion reconstruction method based on hybrid representation enhancement.

### BACKGROUND

The heart, as a vital organ in the human circulatory system, plays a crucial physiological role in transporting blood and essential nutrients to tissues throughout the body. The anatomical structure of the heart is primarily composed of cardiac muscle tissue, with its internal chambers divided into four parts: the left atrium, left ventricle, right atrium, and right ventricle. Severe lesions in the cardiac veins or arteries may lead to major cardiovascular diseases, posing a serious threat to human health. With the continuous improvement of material living standards and ongoing social development in China, significant changes have occurred in contemporary lifestyles. These changes are primarily reflected in the quality of life and daily habits of residents. Unhealthy lifestyle practices, such as alcohol consumption, tobacco use, irregular sleep patterns, physical inactivity, and overeating, have become increasingly prevalent. Consequently, these changes are contributing to a year-on-year rise in the incidence of cardiovascular diseases.

Cardiac 4D reconstruction technology plays a pivotal role in the diagnosis and treatment of cardiovascular diseases. It not only provides three-dimensional (3D) structural information of the heart but also visualizes its dynamic function over time, which is essential for understanding complex hemodynamic patterns and cardiac function. Specifically, 4D flow magnetic resonance imaging (MRI) technology has been demonstrated to quantify hemodynamic changes in cardiac blood flow and plays a critical role in postoperative assessment for patients with heart disease. For instance, studies confirm that 4D Flow MRI is feasible for targeted evaluation of hemodynamics in Fontan circulation, enabling visualization of complex flow patterns, quantification of blood flow distribution, and assessment of vascular geometry. Furthermore, 4D Flow MRI data can quantify left ventricular hemodynamic forces acting on the myocardium, thereby providing a novel tool for investigating adverse cardiac remodeling. In patients with hypertrophic cardiomyopathy (HCM), 4D flow MRI can characterize alterations in hemodynamics and myocardial extracellular volume fraction (ECV), revealing potential links between HCM-related blood flow abnormalities and left ventricular structural remodeling.

In recent years, deep learning-based mesh reconstruction methods have achieved unification through data-driven learning mechanisms. These methods perform excellent in processing complex cardiac imaging data, extracting features and representations, while demonstrating robustness and adaptability to individual patients and modal characteristics. Kong et al. addressed the challenge of topology preservation in cardiac reconstruction by employing neural networks to resolve disconnected regions and anatomical inconsistencies. Bai et al. provided a biventricular cardiac atlas-based method, constructing a heart atlas by analyzing over 1,000 high-resolution MR images and examining cardiac shape and motion for reconstruction. Meng et al. developed a deep learning-based cardiac motion tracking method utilizing neural networks to trace 3D motion in cardiac MRI. Moreover, Qiao et al. introduced a conditional spatiotemporal generative model for simulating cardiac anatomical structures. These methods have demonstrated significant advances in the domain of 4D cardiac reconstruction.

At present, numerous studies have focused on 4D cardiac reconstruction, but the 4D cardiac reconstruction still faces critical challenges.
(1) Reconstruction from sparse data: during surgical or interventional periods, factors such as device limitations, patient conditions, and time constraints often permit acquisition of only partial key frames or discontinuous imaging data, resulting in sparse data. Reconstructing complete 3D cardiac motion from such sparse data constitutes a computationally demanding task, particularly given the heart's complex, non-rigid structure.
(2) Multimodal data fusion: effectively integrating different types of data, such as MRI slices, echocardiography, and electrocardiogram (ECG) signals, presents significant challenges. Data from different modalities exhibit distinct characteristics and resolutions. For instance, MRI delivers high-resolution anatomical structural information, whereas ECG provides signals of cardiac electrophysiological activity. The spatiotemporal heterogeneity of these data poses challenges for fusion algorithms.
(3) Maintaining anatomical consistency: the heart is a complex organ, and its internal structure includes multiple chambers, valves, and vasculature. These structures are morphologically and functionally interdependent, necessitating precise representation of intricate anatomical relationships during reconstruction. Simultaneously, cardiac motion is a continuous process, requiring 4D reconstructions to maintain temporal consistency across sequences, thereby ensuring that cardiac dynamic changes are smooth and continuous without abrupt shifts or unnatural discontinuities. Consequently, maintaining anatomical consistency in reconstruction results poses a challenge.
(4) Multi-directional motion capture: as a dynamic organ, the heart exhibits complex and variable motion patterns including longitudinal shortening during systole, radial thickening, and ventricular rotation, demonstrating significant inter-individual variability influenced by factors such as age, sex, health status, and genetic predisposition. Moreover, cardiac motion is influenced not only by its internal anatomical structures but also by surrounding tissues such as the lungs, diaphragm, and thoracic wall, making multi-directional motion capture a significant challenge for 4D cardiac reconstruction.

### SUMMARY

An objective of the present disclosure is to provide a 4D cardiac motion reconstruction method based on hybrid representation enhancement. Through a deep marching tetrahedra (DMTet) algorithm, a 3D space is discretized into a deformable tetrahedral mesh, providing a foundation for subsequent model training to capture finer geometric details. Furthermore, during 3D reconstruction, a hybrid representation enhancement method is employed, which combines implicit surface representation and explicit mesh representation techniques. Built upon the provided observation encoder, this method is used for extracting features from various types of observational data, and these extracted features are leveraged for subsequent cardiac motion recovery. Simultaneously, during motion recovery, a graph convolutional network (GCN) and a gated recurrent unit (GRU) are combined to help the model effectively process both spatial and temporal information.

To realize the above objective, the present disclosure provides the following technical solutions. A 4D cardiac motion reconstruction method based on hybrid representation enhancement includes the steps of:
S1, cardiac model parameterization: performing parameterization on a heart using a DMTet algorithm, and discretizing a 3D space into a deformable tetrahedral mesh, each vertex having a signed distance function (SDF) value;
S2, generation of an initial 3D model: encoding an image I⁰ and decoding it into a tetrahedral mesh [symbol] , employing a no new U-Net (nnUNet) model for image encoding, with this model being an adaptive U-Net architecture capable of dynamically adjusting a network topology based on a geometric structure of the input image, enhancing model performance using leaky rectified linear units (Leaky ReLUs) and instance-normalization, and creating an initial tetrahedral mesh using the 3D nnUNet through uniform sampling of a unit cube;
S3, construction of an observation encoder: transforming 3D volumes, 2-dimensional (2D) slices, and one-dimensional (1D) data into useful features for cardiac motion prediction, specifically including two parts: spatial observation and 1D observation;
S4, cardiac motion recovery: giving a feature map F⁰ extracted from I⁰ and the tetrahedral mesh [symbol] , along with a feature map \hat{F}^{t} acquired at a moment of t, denoted as

$${\hat{F}}_{3 D}^{t}$$

when using the 2D slices and

$${\hat{F}}_{1 D}^{t}$$

when using the 1D data, and instantiating the above [symbol] deformable model as GCN and GRU layers to effectively aggregate spatial information; and
S5, network model training: leveraging existing key frame annotations for supervised learning to achieve precise reconstruction of cardiac structures, and employing a weakly-supervised learning method to train the deformable model and process unannotated image sequences.

Preferably, in S1, the SDF values are represented by the following formula:

$$𝒢 = ( \{ {v}_{i} \} , \{ {s}_{i} \} , T )$$

where vᵢ and sᵢ are all vertices and the corresponding SDF values for the tetrahedral mesh in a tetrahedral set T, and a surface is obtained through a tetrahedral algorithm; during practical reasoning in a surgical model scenario, an initial model [symbol] , pre-constructed before intervention onset, is provided, and a real-time deformation observation O^{t} is acquired at each subsequent moment of t; and a new model [symbol] is constructed by manipulating vertices of [symbol] to incorporate deformations, with this process being formalized as follows:

$${𝒢}^{t} = ( \{ {v}_{i}^{t} \} , \{ {s}_{i} \} , T )$$

$${v}_{i}^{t} = 𝒟 ( {v}_{i}^{0} , {I}^{0} , {O}^{t} )$$

where

$${v}_{i}^{0}$$

is a vertex of the [symbol] mesh,

$${v}_{i}^{t}$$

is a deformed vertex, I⁰ is an image at the first frame, and [symbol] is a deformable model to be instantiated subsequently that recovers deformations across the entire sequence; an online setup is simulated using a volumetric MRI sequence

$${\{ {I}^{t} ∈ {ℝ}^{D \times H \times W} \}}_{t = 0}^{T} ,$$

and [symbol] is reconstructed using a first partial sequence, with O^{t} as either a 2D slice of I^{t} or 1D volumetric information inferred therefrom; and [symbol] is acquired from different sequences in practical deployment.

Preferably, in S2, the U-Net architecture includes 2D U-Net, 3D U-Net, and U-Net Cascade configurations.

Preferably, in S2, to decode the output of the nnUNet into precise vertex coordinates and SDF values for each vertex, the feature map F⁰∈ [symbol] is extracted from a final layer of upsampling stream, where C denotes the number of feature channels, and trilinear interpolation is performed on the feature map over the [symbol] tetrahedral mesh, with algorithmic steps as follows:
S2.1, selection of known point selecting four known points approaching target interpolation points as closely as possible, and assuming these points to be located at (x₀, y₀), (x₁, y₁), (x₂, y₂), and (x₃, y₃), with x coordinates in ascending order;
S2.2, definition of cubic polynomial: assuming an interpolation function within an interval [x1, x2] to be a cubic polynomial with the following form:

$$P ( x ) = {ax}^{3} + {bx}^{2} + cx + d$$

S2.3, establishment of equation system: utilizing information from the known points to determine coefficients under the following four conditions:

$$\{ \begin{matrix}{ax}_{1}^{3} + {bx}_{1}^{2} + {cx}_{1} + d = {y}_{1} \\ {ax}_{2}^{3} + {bx}_{2}^{2} + {cx}_{2} + d = {y}_{2} \\ 3 {ax}_{1}^{2} + 2 {bx}_{1} + c = \frac{{y}_{2} - {y}_{0}}{{x}_{2} - {x}_{0}} \\ 3 {ax}_{2}^{2} + 2 {bx}_{2} + c = \frac{{y}_{3} - {y}_{1}}{{x}_{3} - {x}_{1}}\end{matrix}$$

S2.4, solution of equation system: solving the above linear equation system to obtain the coefficients a, b, c, and d; and
S2.5: calculation of interpolation points: calculating interpolations for any point within the interval [x1, x2] using the cubic polynomial P(x), and predicting both SDF values and offsets for each vertex using the GCN to construct the [symbol] , with the offset between the deformed tetrahedral mesh [symbol] and a template mesh being expressed by the following formula:

$${𝒢}^{0} = ( \{ {v}_{i}^{′} \} , \{ {s}_{i} \} , T )$$

$${v}_{i}^{′} = {v}_{i} + Δ {v}_{i}$$

$$( Δ {v}_{i} , {s}_{i} ) = GCN ( [ {F}^{0} ( {v}_{i} ) , {v}_{i} ] )$$

where vᵢ is a vertex of the mesh [symbol] ,

$${v}_{i}^{′}$$

is a deformed vertex corresponding to vᵢ, and F⁰(v) represents features extracted at vertex v from F⁰ using trilinear interpolation; and to enhance the network's spatial sensitivity, vertex positions are first appended to feature vectors prior to fed into the GCN.

Preferably, in S3, the spatial observation involves transforming the 2D slices into the 3D volumes, and the 2D UNet architecture is employed to encode information and extract 2D feature maps from 2D slices, efficiently encoding S sequential 2D slices {

$${I}_{s}^{t} ∈ {ℝ}^{H \times W}$$

|s=1, . . . , S} at time step t; and the 3D volume Î^{t}∈ [symbol] is constructed where selected slices are populated with actual image data, with zero padding applied to the remaining slices, and 3D feature maps

$${\hat{F}}_{3 D}^{t} ∈ {ℝ}^{C \times D \times H \times W}$$

are generated using the 3D nnUNet, with C denoting the number of channels.

Preferably, in S3, during 1D observation, 1D signals like left ventricular volume

$${V}_{L M}^{t} ∈ ℝ$$

are encoded using a 2-layer multilayer perceptron (MLP) network, and an encoded output is formulated as a positional embedding

$${\hat{F}}_{1 D}^{t} = PE ( {V}_{LM}^{t} ) ∈ {ℝ}^{C \times D \times H \times W} ,$$

referring to the Transformer design, where C denotes a feature dimension.

Preferably, in S4, specific formulas for aggregating the spatial information are as follows:

$${F}^{cat} ( {v}_{i}^{( s )} ) = [ {F}^{0} ( {v}_{i}^{( s )} ) , {\hat{F}}^{t} ( {v}_{i}^{( s )} ) ]$$

$${F}^{gcn} ( {v}_{i}^{( s )} ) = GCN ( {F}^{cat} ( {v}_{i}^{( s )} ) )$$

$${h}_{i}^{( s + 1 )} = GRU ( [ {F}^{gcn} ( {v}_{i}^{( s )} ) , {v}_{i}^{( s )} ] , {h}_{i}^{( s )} )$$

$${v}_{i}^{( s + 1 )} = {v}_{i}^{( s )} + MLP ( {v}_{i}^{( s )} , {h}_{i}^{( s + 1 )} )$$

where the first formula represents the extraction of vertex features through trilinear interpolation at corresponding positions, and the subsequent three formulas progressively update vertex positions while aggregating spatial information; the above formulas are repeated s times; and by combining the advantages of implicit surface modeling for detailed shape control with mesh-based motion modeling, a hybrid representation enhancement modeling method is provided that fully leverages the advantages of both paradigms.

Preferably, in S5, the supervised learning has the following specific steps:
S5.1, shape reconstruction phase: randomly selecting an image I along with its corresponding ground truth mesh and segmentation annotations y^{gt}={M^{gt}, L^{gt}} during each training iteration, and further assuming y^{p}={ [symbol] , L^{p}} to be a predicted value of the model, where [symbol] is an output tetrahedral mesh, L^{p} is a segmentation prediction output generated by the nnUNet model, and a training loss function is formulated as follows:

$${ℒ}_{shape} ( I ) = {λ}_{cd} {ℒ}_{cd} ( MT ( {𝒢}^{p} ) , {ℳ}^{gt} ) + {λ}_{SDF} {ℒ}_{SDF} ( {𝒢}^{p} , {ℳ}^{gt} ) + {λ}_{ce} {ℒ}_{ce} ( {L}^{p} , {L}^{g t} )$$

where [symbol] is a Chamfer distance loss, which is used for quantifying a distance between a predicted mesh MT( [symbol] ) and a ground truth mesh [symbol] , evaluating similarity between two point sets, and calculating an average value of minimum distances in two directions; [symbol] is an L1 Loss, which is used for supervising predicted SDF values and ground truth SDF values at tetrahedral mesh vertices, and penalizing deviations between the predicted values and the ground truth values; [symbol] is a cross-entropy loss, which is used for calculating the discrepancy between the predicted segmentation map L^{p} and the ground truth L^{gt}, measuring the discrepancy between the model's predicted probability distribution and a ground truth label distribution; and λ_{cd}, λ_{SDF}, and λ_{ce} are hyperparameters that balance each loss value, set to 1.0, 0.1, and 0.1; and
S5.2, training a model as an objective during motion learning by predicting dynamic deformation of the heart in 3D space using the 1D signals, with a training process including: initializing the observation encoder from a shape reconstruction model, with this encoder being responsible for transforming both 2D or 1D observation data into feature maps; selecting 4D cardiac MRI (4DM) and automated cardiac diagnosis challenge (ACDC) datasets for training: randomly selecting two frames as training samples for the 4DM dataset, and selecting either an end-diastolic (ED) or an end-systolic (ES) frame as a reference frame for the ACDC dataset, with another random frame serving as a target frame; randomly selecting 1 to D 2D slices from annotated frames when using the 2D slices, constructing a pseudo-3D volume Î^{l}, and performing zero padding on unselected slice positions; and generating feature maps

$${F}_{3 D}^{l} and {\hat{F}}_{3 D}^{l}$$

from a full 3D image and the pseudo-3D volume using the nnUNet, predicting the deformations from reference to target frames based on the feature maps through an integrated GRU-MLP architecture using the deformable model [symbol] , and calculating a final loss function by combining Chamfer distance and feature distillation loss, formalized as follows:

$${ℒ}_{motion} ( {I}^{l} , {I}^{u} ) = {ℒ}_{distill} ( {\hat{F}}_{3 D}^{l} , {F}_{3 D}^{l} ) + {ℒ}_{cd} ( MT ( {𝒢}^{u \to l} ) , {ℳ}^{l} ) + {ℒ}_{cd} ( MT ( {\hat{𝒢}}^{u \to l} ) , {ℳ}^{l} )$$

where [symbol] and [symbol] are predicted mesh outputs generated by the [symbol] deformation model when processing input meshes

$${F}_{3 D}^{1} and {\hat{F}}_{3 D}^{1} ;$$

and [symbol] is a ground truth mesh output, [symbol] is a distillation loss, which is realized by comparing a partial observation encoding feature map

$${\hat{F}}_{3 D}^{l}$$

against a full encoding feature map

$${F}_{3 D}^{l} ,$$

and [symbol] is the Chamfer distance loss, which is used for quantifying the distance between the predicted deformed mesh and the ground truth mesh, and primarily evaluating the accuracy of motion inferred by the model from partial observation.

Preferably, in S5.2, a training objective is a 2D MRI slice-based model.

Preferably, in S5.2, the 4DM dataset provides ground truth segmentation annotations and mesh annotations for all frames, and the ACDC dataset only offers annotations during ED and ES phases.

Compared to the related art, the present disclosure has the following beneficial effects.

1. To address sparse data reconstruction problems, the present disclosure employs DMTet technology, which discretizes 3D space into a deformable tetrahedral mesh. Each vertex is assigned an SDF that estimates the target SDF throughout the volumetric domain. Crucially, this method achieves theoretically infinite resolution, distinct from voxel-based methods, and enables simulation of intra-surface interactions, which is unlike conventional triangulation techniques.

2. To address multimodal data fusion problems, the present disclosure employs a universal observation encoder to process heterogeneous signal information. For 2D slices, this framework constructs 3D volumes, in which selected slices are populated with actual imaging data, and 3D feature maps are generated using the nnU-Net architecture, ensuring inter-slice interactions while maintaining the capability to process an arbitrary number of slices. For 1D signals, the present disclosure employs a 2-layer MLP for encoding as positional embeddings, which are broadcasted to each vertex of the model, enhancing the model's capability to process multimodal data in cardiac imaging and intervention.

3. To address anatomical consistency preservation, the present disclosure employs the GCN coupled with GRU to predict per-vertex offset rather than absolute positions. This method allows the model to simulate cardiac dynamic deformations in a natural and coherent manner. By leveraging trilinear interpolation for feature extraction, GCN for spatial information aggregation, GRU for vertex state updating, and MLP for vertex offset prediction, it can effectively capture the complex motion patterns of cardiac deformation from forward flow dynamics while maintaining computational efficiency and rapid adaptability to real-time data fluctuations.

4. To address multi-directional motion capture challenges, in the present disclosure, the deformable model is instantiated using the integrated GRU-MLP architecture, allowing the model to effectively aggregate spatial information and dynamically update vertex positions. The GRU layers can process time-series data, capturing the dynamic temporal variations of cardiac motion, while the MLP layers can predict vertex offsets. By using this integrated architecture, the model can effectively capture multi-directional cardiac motions while maintaining temporal coherence and plausible deformation patterns.

### BRIEF DESCRIPTION OF THE DRAWINGS

FIG. 1 is a detailed architecture diagram of a method of the present disclosure;

FIG. 2 is a schematic diagram showing online 4D reconstruction for cardiac motion; and

FIG. 3 is a schematic diagram showing motion reconstruction results using different methods on a 4DM dataset.

### DETAILED DESCRIPTION

The technical solutions in the embodiment of the present disclosure are further described clearly and completely below in combination with the accompanying drawings. Obviously, the embodiments described are only some, rather than all embodiments of the present disclosure. Based on the embodiment of the present disclosure, all other embodiments obtained by those ordinary skilled in the art without creative efforts fall within the scope of protection of the present disclosure.

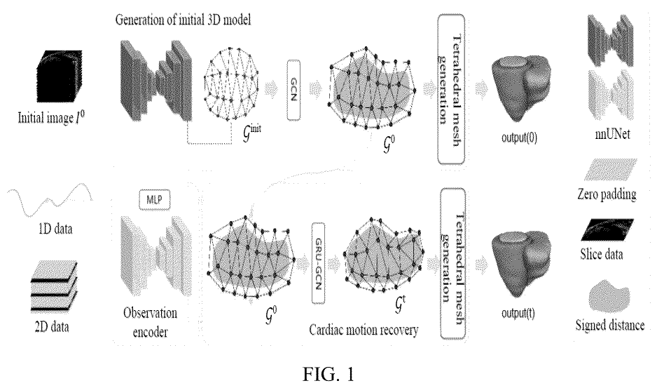

A 4D cardiac motion reconstruction method based on hybrid representation enhancement includes the steps of: cardiac model parameterization, generation of initial 3D model, construction of an observation encoder, cardiac motion recovery, network model training and experimental verification. A technical route of the present disclosure can reconstruct 3D motion from 3D, 2D, or even 1D data, with a detailed architecture shown in FIG. 1. The following steps outline a motion reconstruction pipeline of the present disclosure, which represents deformable objects as dynamic tetrahedral meshes. Moreover, the design of an observation encoder is introduced to encode information from heterogeneous signals, with a particular focus on a pseudo-3D encoder constructed by the present disclosure, which can efficiently aggregate information from an arbitrary number of 2D slices. This method includes the steps that:

In S1, cardiac model parameterization: parameterization is performed on a heart using a DMTet algorithm. DMTet is a deep 3D conditional generative model capable of leveraging coarse voxels or noisy point clouds to synthesize high-resolution 3D shapes. Specifically, the 3D space is discretized into a deformable tetrahedral mesh, and each vertex has an SDF value, represented by the following formula:

$$𝒢 = ( \{ {v}_{i} \} , \{ {s}_{i} \} , T )$$

where vᵢ and sᵢ are all vertices and the corresponding SDF values for the tetrahedral mesh in a tetrahedral set T, and a surface is obtained through a tetrahedral algorithm; during practical reasoning in a surgical model scenario, an initial model [symbol] , pre-constructed before intervention onset, is provided, and a real-time deformation observation O^{t} is acquired at each subsequent moment of t; and a new model [symbol] is constructed by manipulating vertices of [symbol] to incorporate deformations, with this process being formalized as follows:

$${𝒢}^{t} = ( \{ {v}_{i}^{t} \} , \{ {s}_{i} \} , T )$$

$${v}_{i}^{t} = 𝒟 ( {v}_{i}^{0} , {I}^{0} , {O}^{t} )$$

where

$${v}_{i}^{0}$$

is a vertex of the [symbol] mesh,

$${v}_{i}^{t}$$

is a deformed vertex, I⁰ is an image at the first frame, and [symbol] is a deformable model to be instantiated subsequently that recovers deformations across the entire sequence; an online setup is simulated using a volumetric MRI sequence

$${\{ {I}^{t} ∈ {ℝ}^{D \times H \times W} \}}_{t = 0}^{T} ,$$

and [symbol] is reconstructed using a first partial sequence, with O^{t} as either a 2D slice of I^{t} or 1D volumetric information inferred therefrom; and [symbol] is acquired from different sequences in practical deployment, but this is essentially no different since the same algorithm can be applied to deform it from intraoperative sequences.

In S2, generation of initial 3D model: an image I⁰ is encoded, and decoded into a tetrahedral mesh [symbol] . Specifically, an nnUNet model is employed for image encoding. This model is an adaptive U-Net architecture technically designed for medical image segmentation, including 2D U-Net, 3D U-Net, and U-Net Cascade configurations, and it can dynamically adjust a network topology based on a geometric structure of the input image, and enhance model performance using Leaky ReLUs and instance-normalization. Herein, an initial tetrahedral mesh is created using the 3D nnUNet through uniform sampling of a unit cube. To decode the output of the nnUNet into precise vertex coordinates and SDF values for each vertex, the feature map F⁰∈ [symbol] is extracted from a final layer of upsampling stream, where C denotes the number of feature channels, and trilinear interpolation is performed on the feature map over the [symbol] tetrahedral mesh, with algorithmic steps as follows:

In S2.1, selection of known points: four known points approaching target interpolation points as closely as possible are selected, and these points are assumed to be located at (x₀, y₀), (x₁, y₁), (x₂, y₂), and (x₃, y₃), with x coordinates in ascending order.

In S2.2, definition of cubic polynomial: an interpolation function within an interval [x1, x2] is assumed to be a cubic polynomial with the following form:

$$P ( x ) = {ax}^{3} + {bx}^{2} + cx + d$$

In S2.3, establishment of equation system: information from the known points is utilized to determine coefficients under the following four conditions:

$$\{ \begin{matrix}{ax}_{1}^{3} + {bx}_{1}^{2} + {cx}_{1} + d = {y}_{1} \\ {ax}_{2}^{3} + {bx}_{2}^{2} + {cx}_{2} + d = {y}_{2} \\ 3 {ax}_{1}^{2} + 2 {bx}_{1} + c = \frac{{y}_{2} - {y}_{0}}{{x}_{2} - {x}_{0}} \\ 3 {ax}_{2}^{2} + 2 {bx}_{2} + c = \frac{{y}_{3} - {y}_{1}}{{x}_{3} - {x}_{1}}\end{matrix}$$

In S2.4, solution of equation system: the above linear equation system are solved to obtain the coefficients a, b, c, and d.

In S2.5: calculation of interpolation points: interpolations for any point within the interval [x1, x2] are calculated using the cubic polynomial P(x), and both SDF values and offsets for each vertex are predicted using the GCN to construct the [symbol] , with the offset between the deformed tetrahedral mesh [symbol] and a template mesh being expressed by the following formula:

$${𝒢}^{0} = ( \{ {v}_{i}^{′} \} , \{ {s}_{i} \} , T )$$

$${v}_{i}^{′} = {v}_{i} + Δ {v}_{i}$$

$$( Δ {v}_{i} , {s}_{i} ) = GCN ( [ {F}^{0} ( {v}_{i} ) , {v}_{i} ] )$$

where vᵢ is a vertex of the mesh [symbol] ,

$${v}_{i}^{′}$$

is a deformed vertex corresponding to vᵢ, and F⁰(v) represents features extracted at vertex v from F⁰ using trilinear interpolation; and to enhance the network's spatial sensitivity, vertex positions are first appended to feature vectors prior to fed into the GCN.

In S3, construction of an observation encoder: 3D volumes, 2D slices, and 1D data are transformed into useful features for cardiac motion prediction, specifically including two parts: spatial observation and 1D observation. The spatial observation aims to transform 2D slices into 3D volumes. However, efficiently encoding S 2D slices

$$\{ {I}_{s}^{t} ∈ {ℝ}^{H \times W} \vert s = 1 , ... , S \}$$

at time step t remains challenging. A common practice is to use 2D U-Net networks for information encoding and extract 2D feature maps from individual slices. Nevertheless, this approach has inherent limitations. Since each feature map is independently encoded by the 2D U-Net, the resulting feature maps lack 3D consistency, and processing each slice in isolation prevents the model from learning the 3D contextual information inherent in MRI sequences during training. The approach of the present disclosure involves creating a 3D volume Î^{t}∈ [symbol] where selected slices are populated with actual image data, while zero padding is performed on the remaining slices. Moreover, in the present disclosure, 3D feature maps

$${\hat{F}}_{3 D}^{t} ∈ {ℝ}^{C \times D \times H \times W}$$

are generated using the 3D nnUNet, with C denoting the number of channels. This approach can ensure meaningful interaction between 2D slices while preserving 3D information and consistency. Moreover, it can process an arbitrary number of slices.

During 1D observation, 1D signals like left ventricular volume

$${V}_{LM}^{t} ∈ ℝ$$

are encoded using a 2-layer MLP network, and an encoded output is formulated as a positional embedding

$${\hat{F}}_{1 D}^{t} = PE ( {V}_{LM}^{t} ) ∈ {ℝ}^{C \times D \times H \times W} ,$$

referring to the Transformer design, where C denotes a feature dimension. A reason behind selecting volumetric metrics as the encoding target in present disclosure lies in the fact that numerous cardiac function assessments rely on such measurements, with the left ventricular ejection fraction (LVEF) serving as a prime example.

In S4, cardiac motion recovery: a feature map F⁰ extracted from I⁰ and the tetrahedral mesh [symbol] is given, along with a feature map \hat{F}^{t} acquired at a moment of t, denoted as

$${\hat{F}}_{3 D}^{t}$$

when using the 2D slices and

$${\hat{F}}_{1 D}^{t}$$

when using the 1D data. The above [symbol] deformable model is instantiated as GCN and GRU layers to effectively aggregate spatial information, with specific formulas as follows:

$${F}^{c a t} ( {v}_{i}^{( s )} ) = [ {F}^{0} ( {v}_{i}^{( s )} ) , {\hat{F}}^{t} ( {v}_{i}^{( s )} ) ]$$

$${F}^{g c n} ( {v}_{i}^{( s )} ) = G C N ( {F}^{c a t} ( {v}_{i}^{( s )} ) )$$

$${h}_{i}^{( s + 1 )} = G R U ( [ {F}^{g c n} ( {v}_{i}^{( s )} ) , {v}_{i}^{( s )} ] , {h}_{i}^{( s )} )$$

$${v}_{i}^{( s + 1 )} = {v}_{i}^{( s )} + M L P ( {v}_{i}^{( s )} , {h}_{i}^{( s + 1 )} )$$

where the first formula represents the extraction of vertex features through trilinear interpolation at corresponding positions, and the subsequent three formulas progressively update vertex positions while aggregating spatial information; the above formulas are repeated s times; and by combining the advantages of implicit surface modeling for detailed shape control with mesh-based motion modeling, a hybrid representation enhancement modeling method is provided that fully leverages the advantages of both paradigms.

In S5, network model training: data annotation for complete image sequences is prohibitively expensive, which explains why many medical datasets only contain annotations for specific key frames, such as ED and ED in cardiac imaging, thereby precluding the use of fully supervised learning methodologies. In the present disclosure, existing key frame annotations are leveraged for supervised learning to achieve precise reconstruction of cardiac structures, and a weakly-supervised learning method is employed to train the deformable model, thereby processing unannotated image sequences, with specific steps as follows:
In S5.1, shape reconstruction phase: during each training iteration, an image I is randomly selected, along with its corresponding ground truth mesh and segmentation annotations y^{gt}={M^{gt}, L^{gt}}, and y^{p}={ [symbol] , L^{p}} is further assumed to be a predicted value of the model, where [symbol] is an output tetrahedral mesh, L^{p} is a segmentation prediction output generated by the nnUNet model, and a training loss function is formulated as follows:

$${ℒ}_{s h a p e} ( I ) = {λ}_{c d} {ℒ}_{c d} ( MT ( {𝒢}^{p} ) , {ℳ}^{g t} ) + {λ}_{SDF} {ℒ}_{SDF} ( {𝒢}^{p} , {ℳ}^{g t} ) + {λ}_{c e} {ℒ}_{c e} ( {L}^{p} , {L}^{g t} )$$

where [symbol] is a Chamfer distance loss, which is used for quantifying a distance between a predicted mesh MT( [symbol] ) and a ground truth mesh [symbol] , evaluating similarity between two point sets, and calculating an average value of minimum distances in two directions; [symbol] is an L1 Loss, which is used for supervising predicted SDF values and ground truth SDF values at tetrahedral mesh vertices, and penalizing deviations between the predicted values and the ground truth values; [symbol] is a cross-entropy loss, which is used for calculating the discrepancy between the predicted segmentation map L^{p} and the ground truth L^{gt}, measuring the discrepancy between the model's predicted probability distribution and a ground truth label distribution; and λ_{cd}, λ_{SDF}, and λ_{ce} are hyperparameters that balance each loss value, set to 1.0, 0.1, and 0.1.

In S5.2, during motion learning, the objective is to train a model capable of predicting dynamic deformation of the heart in the 3D space based on real-time sparse observation data, such as 2D MRI slices and 1D signals, with a training process as follows: the observation encoder is initialized from a shape reconstruction model, and this encoder is responsible for transforming both 2D or 1D observation data into feature maps, with these feature maps used in the subsequent deformation model; and training samples are selected. In the present disclosure, 4DM and ACDC datasets are selected for training. The 4DM dataset provides ground truth segmentation annotations and mesh annotations for all frames, whereas the ACDC dataset only offers annotations specifically for ED and ES phases. For the 4DM dataset, two frames are randomly selected as training samples. For the ACDC dataset, either an ED or an ES frame is selected as a reference frame, with another random frame serving as a target frame. When using the 2D slices, 1 to D 2D slices are randomly selected from annotated frames, and a pseudo-3D volume Î^{l} is constructed, with zero padding applied to unselected slice positions. Furthermore, feature maps

$${F}_{3 D}^{l} and {\hat{F}}_{3 D}^{l}$$

are generated from a full 3D image and the pseudo-3D volume using the nnUNet, and the deformations from reference to target frames are predicted based on the feature maps through an integrated GRU-MLP architecture using the deformable model [symbol] , and a final loss function is calculated by combining Chamfer distance and feature distillation loss, formalized as follows:

$${ℒ}_{m o t i o n} ( {I}^{l} , {I}^{u} ) = {ℒ}_{d istill} ( {\hat{F}}_{3 D}^{l} , {F}_{3 D}^{l} ) + {ℒ}_{c d} ( MT ( {𝒢}^{u \to l} ) , {ℳ}^{1} ) + {ℒ}_{c d} ( M T ( {\hat{𝒢}}^{u \to 1} ) , {ℳ}^{l} )$$

where [symbol] and [symbol] are predicted mesh outputs generated by the [symbol] deformation model when processing input meshes

$${F}_{3 D}^{l} and {\hat{F}}_{3 D}^{l} ;$$

and [symbol] is a ground truth mesh output, [symbol] is a distillation loss, which is used for ensuring that the feature maps encoded from partial observations (e.g., 2D slices) retain sufficient 3D information to facilitate accurate motion estimation. The distillation loss is realized by comparing the partial observation encoding feature map

$${\hat{F}}_{3 D}^{l}$$

against a full encoding feature map

$${F}_{3 D}^{l} .$$

Moreover, [symbol] is the Chamfer distance loss, which is used for quantifying the distance between the predicted deformed mesh and the ground truth mesh, and primarily evaluating the accuracy of motion inferred by the model from partial observation.

### Experimental Verification

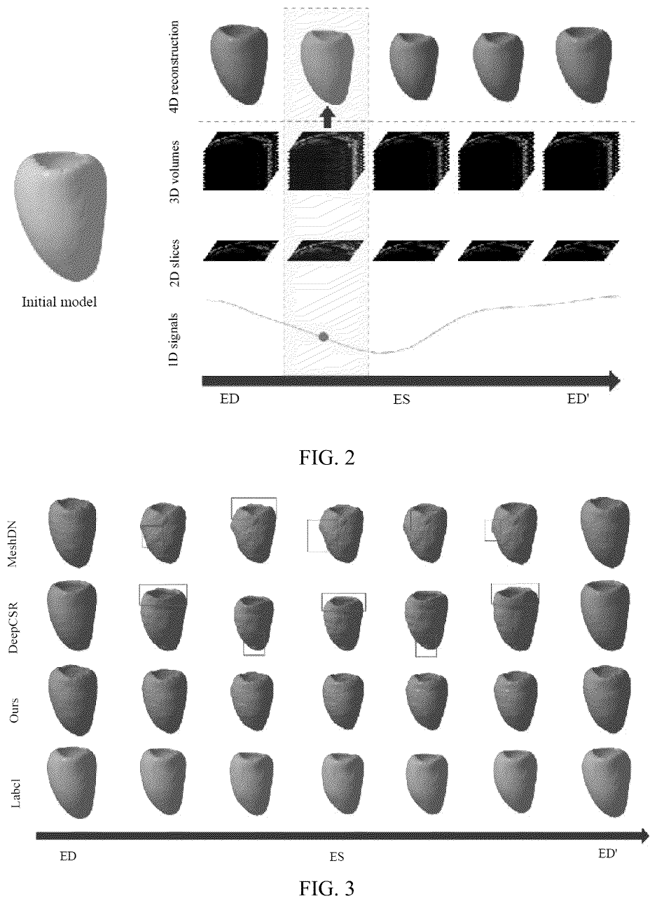

The method of the present disclosure is trained and evaluated using the 4DM and ACDC datasets. FIG. 2 demonstrates 4D cardiac reconstruction results achieved with 2D slices and 1D signals. Empirical validation confirms that the model can accommodates arbitrary numbers of 2D slices during inference. Furthermore, the model can cater not only to full 3D volumes but also to sparser 2D slices and even 1D signals, thereby realizing multimodal capabilities in 4D cardiac reconstruction.

FIG. 3 demonstrates cardiac motion reconstruction results on the 4DM dataset across different methods. It can be seen from the experiment that the method of the present disclosure can achieve superior reconstruction fidelity, particularly in refining reconstruction details to yield smoother outcomes that closely align with the ground truth labels.

In the method of the present disclosure, through the DMTet algorithm, the 3D space is discretized into a deformable tetrahedral mesh. Compared to voxel-based methods, tetrahedral mesh-based methods offer theoretically infinite resolution, providing a foundation for subsequent model training to capture finer geometric details. Furthermore, during 3D reconstruction, a hybrid representation enhancement method is employed, which combines implicit surface representation and explicit mesh representation techniques. Built upon the provided observation encoder, this method is used for extracting features from various types of observational data, and these extracted features are leveraged for subsequent cardiac motion recovery. Simultaneously, during motion recovery, GCN and GRU are combined to help the model effectively process both spatial and temporal information.

In the related art, the voxel-based methods are employed to represent 3D space. In the present disclosure, the DMTet algorithm is employed to discretize the 3D space into a deformable tetrahedral mesh. This tetrahedral mesh-based method provides theoretically infinite resolution, enabling the capture of finer geometric details, particularly valuable for simulating complex cardiac shapes and surfaces. Each vertex in the tetrahedral mesh is assigned an SDF value, allowing the mesh to represent dynamically changing shapes. By modifying these SDF values, dynamic motions of organs like the heart can be simulated.

In the related art, during cardiac motion reconstruction, reliance on either a single implicit surface representation or explicit mesh representation presents critical limitations. When using the single implicit surface representation, performance degrades during topology-sensitive operations. Conversely, explicit mesh representations exhibit poor detail capture capability, as highly intricate geometries require an excessive number of vertices for accurate modeling, thereby increasing data complexity and processing costs. By integrating the above two methods, the present disclosure provides an enhanced hybrid representation framework based on DMTet algorithm improvement, performing detailed shape modeling while controlling motion dynamics, thereby ensuring plausible and coherent reconstructed motions.

In the related art, for 2D slice processing, a common approach is to independently encode each 2D slice using the 2D U-Net to obtain 2D feature maps per slice, resulting in a lack of 3D spatial consistency across the feature maps, as each feature map is generated in isolation from other slices. Furthermore, the related art often assume that all slices are stacked in a fixed configuration for feature extraction. However, in real-world applications, only slices with inconsistent quantities and positions are available. In the present disclosure, the observation encoder is constructed that incorporates the pseudo-3D encoder for 2D slice data, and the selected 2D slices are filled into 3D volumes, with unfilled slices applied to zero padding, thereby preserving 3D spatial consistency during 2D slice processing. For 1D data, the 2-layer MLP is employed for encoding, which serves as positional embeddings, thereby enhancing the efficiency and effectiveness of 1D feature extraction. Moreover, the observation encoder allows the model to flexibly process diverse input data while extracting useful features for improved 3D cardiac motion reconstruction.

In the related art, during motion recovery, convolutional neural network (CNN)-based methods are predominantly employed, which fail to resolve complex cardiac structures. In contrast, the present disclosure employs the integrated GCN-GRU architecture. The GCN is capable of operating directly on graph-structured data, making them exceptionally suited for processing non-regular meshes or tetrahedral meshes. By aggregating information from neighboring nodes and updating features of each node, the GCN is capable of capturing the local connection patterns of nodes, facilitating heart motion recovery. The GRU is skilled in processing time-series data, enabling it to capture the dynamic motion patterns of the heart over time. In clinical practice, cardiac imaging data is often acquired with non-uniform intervals. The GRU demonstrates robust adaptability to varying time steps, enabling greater flexibility in processing clinical cardiac imaging data. By integrating the GCN and the GRU, the model can effectively process spatial and temporal information, facilitating effective handling of complex cardiac motions, particularly under sparse data conditions.

It is to be noted that, herein, relational terms such as “first” and “second” are used merely to distinguish one entity or operation from another, and do not necessarily require or imply that any such actual relationship or order exists between those entities or operations. Furthermore, the term “comprise”, “include”, or any other variation thereof are intended to cover a non-exclusive inclusion, so that a process, method, article, or apparatus with a series of elements includes not only those elements but also other elements not explicitly listed, or elements inherent to such process, method, article, or apparatus. Without further more limitations, elements limited by statements “comprises a . . . ” do not preclude the existence of other identical elements in the process, method, article or device.

Although the above embodiments of the present disclosure have been shown and described, a person of ordinary skill in the art may make several changes, modifications, substitutions and variations without departing from the principles and spirit of the present disclosure, and the scope of the present disclosure is limited by the attached claims and equivalents thereof.

1. A four-dimensional (4D) cardiac motion reconstruction method based on hybrid representation enhancement, comprising the steps of:
S1, cardiac model parameterization: performing parameterization on a heart using a deep marching tetrahedra (DMTet) algorithm, and discretizing three-dimensional (3D) space into a deformable tetrahedral mesh, each vertex having a signed distance function (SDF) value;
S2, generation of initial 3D model: encoding an image I⁰ and decoding it into a tetrahedral mesh [symbol] , employing a no new U-Net (nnUNet) model for image encoding, with this model being an adaptive U-Net architecture capable of dynamically adjusting a network topology based on a geometric structure of the input image, enhancing model performance using leaky rectified linear units (Leaky ReLUs) and instance-normalization, and creating an initial tetrahedral mesh using the 3D nnUNet through uniform sampling of a unit cube;
S3, construction of observation encoder: transforming 3D volumes, 2-dimensional (2D) slices, and one-dimensional (1D) data into useful features for cardiac motion prediction, specifically comprising two parts: spatial observation and 1D observation;
S4, cardiac motion recovery: giving a feature map F⁰ extracted from I⁰ and the tetrahedral mesh [symbol] , along with a feature map \hat{F}^{t} acquired at a moment of t, denoted as
$${\hat{F}}_{3 D}^{t}$$
when using the 2D slices and
$${\hat{F}}_{1 D}^{t}$$
when using the 1D data, and instantiating the above [symbol] deformable model as graph convolutional network (GCN) and gated recurrent unit (GRU) layers to effectively aggregate spatial information; and
S5, network model training: leveraging existing key frame annotations for supervised learning to achieve precise reconstruction of cardiac structures, and employing a weakly-supervised learning method to train the deformable model and process unannotated image sequences.

2. The 4D cardiac motion reconstruction method based on hybrid representation enhancement according to claim 1, wherein in S1, the SDF values are represented by the following formula:
$$𝒢 = ( \{ {v}_{i} \} , \{ {s}_{i} \} , T )$$
where vᵢ and sᵢ are all vertices and the corresponding SDF values for the tetrahedral mesh in a tetrahedral set T, and a surface is obtained through a tetrahedral algorithm; during practical reasoning in a surgical model scenario, an initial model [symbol] , pre-constructed before intervention onset, is provided, and a real-time deformation observation O^{t} is acquired at each subsequent moment of t; and a new model [symbol] is constructed by manipulating vertices of [symbol] to incorporate deformations, with this process being formalized as follows:
$${𝒢}^{t} = ( \{ {v}_{i}^{t} \} , \{ {s}_{i} \} , T )$$
$${v}_{i}^{t} = 𝒟 ( {v}_{i}^{0} , {I}^{0} , {O}^{t} )$$
where
$${v}_{i}^{0}$$
is a vertex of the [symbol] mesh,
$${v}_{i}^{t}$$
is a deformed vertex, I⁰ is an image at the first frame, and [symbol] is a deformable model to be instantiated subsequently that recovers deformations across the entire sequence; an online setup is simulated using a volumetric magnetic resonance imaging (MRI) sequence
$${\{ {I}^{t} ∈ {ℝ}^{D \times H \times W} \}}_{t = 0}^{T} ,$$
and [symbol] is reconstructed using a first partial sequence, with O^{t} as either a 2D slice of I^{t} or 1D volumetric information inferred therefrom; and [symbol] is acquired from different sequences in practical deployment.

3. The 4D cardiac motion reconstruction method based on hybrid representation enhancement according to claim 1, wherein in S2, the U-Net architecture comprises 2D U-Net, 3D U-Net, and U-Net Cascade configurations.

4. The 4D cardiac motion reconstruction method based on hybrid representation enhancement according to claim 1, wherein in S2, to decode the output of the nnUNet into precise vertex coordinates and SDF values for each vertex, the feature map F⁰∈ [symbol] is extracted from a final layer of upsampling stream, where C denotes the number of feature channels, and trilinear interpolation is performed on the feature map over the [symbol] tetrahedral mesh, with algorithmic steps as follows:
S2.1, selection of known points: selecting four known points approaching target interpolation points as closely as possible, and assuming these points to be located at (x₀, y₀), (x₁, y₁), (x₂, y₂), and (x₃, y₃), with x coordinates in ascending order;
S2.2, definition of cubic polynomial: assuming an interpolation function within an interval [x1, x2] to be a cubic polynomial with the following form:
$$P ( x ) = a {x}^{3} + b {x}^{2} + c x + d$$
S2.3, establishment of equation system: utilizing information from the known points to determine coefficients under the following four conditions:
$$\{ \begin{matrix}a {x}_{1}^{3} + b {x}_{1}^{2} + c {x}_{1} + d = {y}_{1} \\ a {x}_{2}^{3} + b {x}_{2}^{2} + c {x}_{2} + d = {y}_{2} \\ 3 a {x}_{1}^{2} + 2 b {x}_{1} + c = \frac{{y}_{2} - {y}_{0}}{{x}_{2} - {x}_{0}} \\ 3 a {x}_{2}^{2} + 2 b {x}_{2} + c = \frac{{y}_{3} - {y}_{1}}{{x}_{3} - {x}_{1}}\end{matrix}$$
S2.4, solution of equation system: solving the above linear equation system to obtain the coefficients a, b, c, and d; and
S2.5: calculation of interpolation points: calculating interpolations for any point within the interval [x1, x2] using the cubic polynomial P(x), and predicting both SDF values and offsets for each vertex using the GCN to construct the [symbol] , with the offset between the deformed tetrahedral mesh [symbol] and a template mesh being expressed by the following formula:
$${𝒢}^{0} = ( \{ {v}_{i}^{′} \} , \{ {s}_{i} \} , T )$$
$${v}_{i}^{′} = {v}_{i} + Δ {v}_{i}$$
$$( Δ {v}_{i} , {s}_{i} ) = G C N ( [ {F}^{0} ( {v}_{i} ) , {v}_{i} ] )$$
where vᵢ is a vertex of the mesh [symbol] ,
$${v}_{i}^{′}$$
is a deformed vertex corresponding to vᵢ, and F⁰ (v) represents features extracted at vertex v from F⁰ using trilinear interpolation; and to enhance the network's spatial sensitivity, vertex positions are first appended to feature vectors prior to fed into the GCN.

5. The 4D cardiac motion reconstruction method based on hybrid representation enhancement according to claim 1, wherein in S3, the spatial observation involves transforming the 2D slices into the 3D volumes, and the 2D UNet architecture is employed to encode information and extract 2D feature maps from 2D slices, efficiently encoding S sequential 2D slices
$$\{ {I}_{s}^{t} ∈ {ℝ}^{H \times W} \vert s = 1 , … , S \}$$
at time step t; and the 3D volume Î^{t}∈ [symbol] is constructed, in which selected slices are populated with actual image data, with zero padding applied to the remaining slices, and 3D feature maps
$${\hat{F}}_{3 D}^{t} ∈ {ℝ}^{C \times D \times H \times W}$$
are generated using the 3D nnUNet, with C denoting the number of channels.

6. The 4D cardiac motion reconstruction method based on hybrid representation enhancement according to claim 1, wherein in S3, during 1D observation, 1D signals like left ventricular volume
$${V}_{L M}^{t} ∈ ℝ$$
are encoded using a 2-layer multilayer perceptron (MLP) network, and an encoded output is formulated as a positional embedding
$${\hat{F}}_{1 D}^{t} = PE ( {V}_{LM}^{t} ) ∈ {ℝ}^{C \times D \times H \times W} ,$$
referring to the Transformer design, where C denotes a feature dimension.

7. The 4D cardiac motion reconstruction method based on hybrid representation enhancement according to claim 1, wherein in S4, specific formulas for aggregating the spatial information are as follows:
$${F}^{c a t} ( {v}_{i}^{( s )} ) = [ {F}^{0} ( {v}_{i}^{( s )} ) , {\hat{F}}^{t} ( {v}_{i}^{( s )} ) ]$$
$${F}^{g c n} ( {v}_{i}^{( s )} ) = G C N ( {F}^{c a t} ( {v}_{i}^{( s )} ) )$$
$${h}_{i}^{( s + 1 )} = G R U ( [ {F}^{g c n} ( {v}_{i}^{( s )} ) , {v}_{i}^{( s )} ] , {h}_{i}^{( s )} ]$$
$${v}_{i}^{( s + 1 )} = {v}_{i}^{( s )} + MLP ( {v}_{i}^{( s )} , {h}_{i}^{( s + 1 )} )$$
where the first formula represents the extraction of vertex features through trilinear interpolation at corresponding positions, and the subsequent three formulas progressively update vertex positions while aggregating spatial information; the above formulas are repeated s times; and by combining the advantages of implicit surface modeling for detailed shape control with mesh-based motion modeling, a hybrid representation enhancement modeling method is provided that fully leverages the advantages of both paradigms.

8. The 4D cardiac motion reconstruction method based on hybrid representation enhancement according to claim 1, wherein in S5, the supervised learning has the following specific steps:
S5.1, shape reconstruction phase: randomly selecting an image I along with its corresponding ground truth mesh and segmentation annotations y^{gt}={M^{gt}, L^{gt}} during each training iteration, and further assuming y^{p}={ [symbol] , L^{p}} to be a predicted value of the model, where [symbol] is an output tetrahedral mesh, L^{p} is a segmentation prediction output generated by the nnUNet model, and a training loss function is formulated as follows:
$${ℒ}_{shape} ( I ) = {λ}_{c d} {ℒ}_{c d} ( MT ( {𝒢}^{p} ) , {ℳ}^{g t} ) + {λ}_{SDF} {ℒ}_{SDF} ( {𝒢}^{p} , {ℳ}^{g t} ) + {λ}_{c e} {ℒ}_{c e} ( {L}^{p} , {L}^{g t} )$$
where [symbol] is a Chamfer distance loss, which is used for quantifying a distance between a predicted mesh MT( [symbol] ) and a ground truth mesh [symbol] , evaluating similarity between two point sets, and calculating an average value of minimum distances in two directions; [symbol] is an L1 Loss, which is used for supervising predicted SDF values and ground truth SDF values at tetrahedral mesh vertices, and penalizing deviations between the predicted values and the ground truth values; [symbol] is a cross-entropy loss, which is used for calculating the discrepancy between the predicted segmentation map L^{p} and the ground truth L^{gt}, measuring the discrepancy between the model's predicted probability distribution and a ground truth label distribution; and λ_{cd}, λ_{SDF}, and λ_{ce} are hyperparameters that balance each loss value, set to 1.0, 0.1, and 0.1; and
S5.2, training a model as an objective during motion learning by predicting dynamic deformation of the heart in the 3D space using the 1D signals, with a training process comprising: initializing the observation encoder from a shape reconstruction model, with this encoder being responsible for transforming both 2D or 1D observation data into feature maps; selecting 4D cardiac MRI (4DM) and automated cardiac diagnosis challenge (ACDC) datasets for training: randomly selecting two frames as training samples for the 4DM dataset, and selecting either an end-diastolic (ED) or an end-systolic (ES) frame as a reference frame for the ACDC dataset, with another random frame serving as a target frame; randomly selecting 1 to D 2D slices from annotated frames when using the 2D slices, constructing a pseudo-3D volume Î¹, and performing zero padding on unselected slice positions; and generating feature maps
$${F}_{3 D}^{l} and {\hat{F}}_{3 D}^{l}$$
from a full 3D image and the pseudo-3D volume using the nnUNet, predicting the deformations from reference to target frames based on the feature maps through an integrated GRU-MLP architecture using the deformable model [symbol] , and calculating a final loss function by combining Chamfer distance and feature distillation loss, formalized as follows:
$${ℒ}_{motion} ( {I}^{l} , {I}^{u} ) = {ℒ}_{distill} ( {\hat{F}}_{3 D}^{l} , {F}_{3 D}^{l} ) + {ℒ}_{c d} ( MT ( {𝒢}^{u \to l} ) , {ℳ}^{l} ) + {ℒ}_{c d} ( M T ( {\hat{𝒢}}^{u \to 1} ) , {ℳ}^{l} )$$
where [symbol] and [symbol] are predicted mesh outputs generated by the [symbol] deformation model when processing input meshes
$${F}_{3 D}^{l} and {\hat{F}}_{3 D}^{l} ;$$
and [symbol] is a ground truth mesh output, [symbol] is a distillation loss, which is realized by comparing a partial observation encoding feature map
$${\hat{F}}_{3 D}^{l}$$
against a full encoding feature map
$${F}_{3 D}^{l} ,$$
and [symbol] is the Chamfer distance loss, which is used for quantifying the distance between the predicted deformed mesh and the ground truth mesh, and primarily evaluating the accuracy of motion inferred by the model from partial observation.

9. The 4D cardiac motion reconstruction method based on hybrid representation enhancement according to claim 8, wherein in S5.2, a training objective is a 2D MRI slice-based model.

10. The 4D cardiac motion reconstruction method based on hybrid representation enhancement according to claim 8, wherein in S5.2, the 4DM dataset provides ground truth segmentation annotations and mesh annotations for all frames, and the ACDC dataset only offers annotations during ED and ES phases.
